(19) United States
(12) Patent Application Publication
(10) Pub. No.: US 2009/0135980 A1
(43) Pub. Date: May 28, 2009

(54) Nuclear Fusion Conducted at Near Absolute Zero Temperatures

(76) Inventor: Rafael Adler, Tel Aviv (IL)

Correspondence Address: ROBERT G. LEV, 4766 MICHIGAN BLVD., YOUNGSTOWN, OH, 44505, US

(21) Appl. No.: 12/084,190

(22) PCT Filed: Nov. 6, 2006
(86) PCT No.: PCT/IL06/01258

§ 371 Date: Apr. 25, 2008

(30) Foreign Application Priority Data
Nov. 6, 2005 (IL) 171784

(51) Int. Cl. G21B 3/00

(52) U.S. Cl. 376/107; 976/DIG. 1

(57) ABSTRACT

A method for producing nuclear fusion in a fusion chamber, comprising the steps of: (a) Obtaining cooled high velocity nuclear particles; (b) Causing said particles to impact a target, and (c) Harvesting the energy thereby released.

### FIELD OF THE INVENTION

The present invention is directed to providing a method and system for cold nuclear fusion.

### BACKGROUND OF THE INVENTION

Quite often, when scientists have difficulty explaining various phenomena, they create scientific models which are based on motion. The phenomena explained by “motion” models exist in physical systems of all sizes, ranging from subatomic systems, through gaseous systems, all the way up to the structure of the universe.

At the Level of the Universe various questions have been modeled in this way. For example, “how can the fact that the universe does not collapse under the attractive force of gravity be explained?” The answer to this question is usually ascribed to motion, as originating with the Big Bang, or is attributed to the properties of matter.

Questions at the Molecular Level such as “How are the behavior of gases to be explained? Or, what is the relationship between pressure, volume and temperature? Once again, motion is attributed to the molecules which make up the gas, and this motion causes collisions between the molecules in the gas.

At the Subatomic Level we find questions such as How is the fact that negatively charged electrons don't fall into the positively charged nucleus? Once again, motion is attributed to the electrons around the nucleus.

The inventor of the system and process to be described herein below has developed alternative explanation (in the style of Einstein's cosmological constant). The proposed solution is summarized in the following short sentence:

“Apparently, among the forces that exist between components of matter there exist also repulsive forces.”

A new physical model will now be presented that can explain various scientific phenomena without reference to motion. This model can also explain in a simple manner all other natural phenomena and can even predict unknown phenomena.

A “Heavenly” Environment of Entities

Lets assume that there's a world called “the heavenly environment”, a world constructed of two entities using names proposed by Dr David Singer:
Yeho
Va

These two entities may be woven with one another into one comprehensive entity:

Yeho-Va

The reciprocity between these entities is as follows:
Between every two Yeho there is a mutual repulsive force, which is written as: F_{YY}.
Between every two Va there is a mutual gravitational force, which is written as: F_{VV}.
Between Yeho and Va there is a mutual attractive force, which is written as: F_{YV}.

The significance of these mutual forces is among others:
1. Va is attracted to both Va and Yeho. Therefore, the chance of finding Va with no Yeho attached to it is very slim.
2. Yeho is attracted to Va, but repelled by Yeho. Therefore, wherever there's a high concentration of Yeho, any additional Yeho may be repelled.
3. Yeho and Va attract each other. From the properties of the forces that act between these two entities and from the symmetry principle, it is reasonable to assume that the particle carrying both has a concentric ball shape. Between every two Va there's an attractive force in action while between every two Yeho there's a repulsive force in action. Therefore one has to assume that the Va is in the center of the particle and the Yeho envelopes (surrounds) it, as shown in FIG. 1.
4. When a Yeho approaches a particle in which both entities are present, it is attracted to the Va at its center and repelled by the Yeho surrounding it. When the attractive force is stronger than the repulsive force, the approaching Yeho is combined with the Yeho that is within the envelope See FIG. 2.

When the joining process continues, the repulsive force acting on every approaching Yeho increases, so that at a certain stage the repulsive force acting on every additional approaching Yeho overcomes the attractive force and its absorption is prevented (FIG. 3).

It is clear that the intensity of the attractive/repulsive forces that are active in the heavenly environment depends on the quantities of the Yeho and the Va.

We shall now try to analyze the properties of these forces, and through them we'll also try to explain what happens in nature, starting at the subatomic level and up to the level of the universe as a whole, hoping that by the end of this background section the reader will realize that this is none other than the world we live in.

From what happens in nature we know that:
1. There are zones in which masses of matter are created with no occurrence of these masses collapsing into each other in an unbridled way.
2. There are Zones in which voids are created such as the void between the nucleus of an atom and its electrons, the void between gas particles, the space between heavenly bodies.
3. There are no occurrences attesting to continuous and unbridled collapse.
4. When the distance between bodies grows, the intensity of the active mutual forces between them decreases.

From the above we can deduce that:

The intensity of the attractive/repulsive forces that are active in the heavenly environment, and probably also in our world, are also dependent on the distance between the entities, and that this dependence is in inverse ratio to the power of -n- of the distance “r” between them.

It is clear that the exponents must be different for the different forces, because if they would be the same, the direction of the resultant force wouldn't change as the distance changed, which is in absolute contradiction to what happens in nature.

We summarize and conclude that:
The intensity of the repulsive force between Yeho and Yeho is in direct proportion to the product of the quantities of Yeho, and in inverse ratio to the distance “r” between them to the power of n₁.

$${F}_{YY} ∝ \frac{{Y}_{1} {Y}_{2}}{{r}^{{n}_{1}}}$$

$$or : \\ {F}_{YY} = {k}_{1} \frac{{Y}_{1} {Y}_{2}}{{r}^{{n}_{1}}}$$

The intensity of the attractive force between Va and

Va is in direct proportion to the product of the quantities of Va, and in inverse ratio to the distance “r” between them to the power of n₂.

$${F}_{VV} ∝ \frac{{V}_{1} {V}_{2}}{{r}^{{n}_{2}}}$$

$$or$$

$${F}_{VV} = - {k}_{2} \frac{{V}_{1} {V}_{2}}{{r}^{{n}_{2}}}$$

The intensity of the attractive force between Yeho and Va is in direct proportion to the product of the quantities of the Yeho and the Va, and in inverse ratio to the distance “r” between them to the power of n₃.

$${F}_{YV} ∝ \frac{YV}{{r}^{{n}_{3}}}$$

$$or : \\ {F}_{YV} = - {k}_{3} \frac{{Y}_{1} {V}_{2}}{{r}^{{n}_{3}}}$$

Let's examine the variation with distance of these three forces.

From the inverse dependence of each of these forces on the distance “r”, it stems that as the distance grows, the strength of each of them decreases. The rate at which it diminishes depends on the exponent of the power of the distance “r”. The bigger the exponent, the faster the rate at which the strength of the force changes. Or in other words, the force with the higher exponent has more influence at short distances, while the force with the lower exponent has significant influence at very long distances.

Following are several arguments which can indicate the relations between the exponents n₁, n₂ and n₃ of the distance “r”.

In many of the situations in nature in which the distance “r” between two particles isn't relatively big, the resultant force between the particles is attractive. In the heavenly environment n1 is the exponent of “r” of the repulsive force, while n₂ and n₃ are exponents of “r” of the attractive force. From this we deduce:

n₁<n₂ and n₁<n₃

Regarding the basic particles like electron and proton, we know four basic facts:
Their dimensions are very small.
They differ from each other in the parameters that characterize them.
They can be found in practically any mater.
Huge forces are required to break them apart.

These facts as well as the fact that in our world there is no infinite accumulation, necessitate the existence of a very strong bond between the Yeho and the Va that are in each of these particles. This will hold true when the exponent of the distance “r” in the formula that determines the type of force that exists between them is large, and therefore it is very likely that:

n₂<n₃

To summarize the above discussion, it is highly probable that

n₁<n₂<n₃

For a given composition of Va and Yeho a graph of the forces discussed above and of the resultant force ΣF as a function of separation “r” is shown below (FIG. 4):
From the dependency of these forces on distance we can deduce that for a given composition of Yeho and Va the following holds true:

When the distance “r” increases, the strength of all the forces decreases, but the rate of change of the repulsive force F_{YY} is smaller than the rate of change of the attractive forces F_{VV} and F_{YV}. There's a distance, which is marked as r_{eq} (see FIG. 4), in which the resultant of these three forces equals zero:

$$\sum F = {k}_{1} \frac{{Y}_{1} {Y}_{2}}{{r}_{eq}^{{n}_{1}}} - {k}_{2} \frac{{V}_{1} {V}_{2}}{{r}_{eq}^{{n}_{2}}} - {k}_{3} ( \frac{{Y}_{1} {V}_{2} + {Y}_{2} {V}_{1}}{{r}_{eq}^{{n}_{3}}} ) = 0$$

When the distance “r” is smaller than req the resultant force is an attractive:

ΣF<0 for r<r_{eq}

When the distance “r” is greater than req the resultant force is a repulsive force:

ΣF<0 for r>r_{eq}

This result could explain among other things why the universe in its cosmic structure is composed of concentrations of mass in between which there are great empty expanses. The fact that at great distances repulsive forces are acting between universal bodies is in fact the equivalent to the cosmological constant that Albert Einstein introduced. In other words, the search for a repulsive force that is active at great distances (Einstein's cosmological constant) is not the big blunder in Einstein's life, but an indispensable step in explaining the cosmological observations according to which the universe isn't collapsing. The explanation offered here is immeasurably simpler than the explanations that are currently popular, like: the expansion of the universe. The creation of expanses out of the blue. The creation of masses in the created expanses. The explanation offered in the heavenly environment is preferable to the widespread use of “infinity in order to explain why the universe didn't collapse until today and will probably not collapse in the future. It will be noted that using “infinity” one can prove practically anything, but nothing can be explained.

It is important to note that the strength of the resultant force approaches to zero as the distance increases to infinity.

The Yeho Field and the Va Field

The forces operating in the heavenly environment between the various entities operate from a distance. In other words, in order for these forces to operate the entities do not necessarily need to touch each other. As is accepted, we'll say that:

Every Yeho creates a Yeho field in the surrounding space. Every point in that field is characterized by two components:

1. Component Ey whose direction is from the Yeho outwards and its strength varies as a function of the distance from the Yeho, in accordance with the function:

$${E}_{Y} ∝ \frac{1}{{r}^{{n}_{1}}}$$

This component influences every Yeho that's in the field.

2. Component By whose direction is toward the Yeho and its strength varies as a function of the distance from the Yeho, in accordance with the function:

$${B}_{Y} ∝ \frac{1}{{r}^{{n}_{3}}}$$

This component affects every Va that's in the field.

When a particle consisting of both Yeho and Va is found in the Yeho field, it is affected by both components of the field.

Every Va creates a Va field in the surrounding space. Also in this field every point is characterized by two components:

1. Component Ev whose direction is toward the Va and its strength varies as a function of the distance from the Va, in accordance with the function:

$${E}_{V} ∝ \frac{1}{{r}^{{n}_{2}}}$$

This component affects every Va that's in it.

2. Component Bv whose direction is toward the Va and its strength varies as a function of the distance from the Va, in accordance with the function:

$${B}_{V} ∝ \frac{1}{{r}^{{n}_{3}}}$$

This component affects every Yeho that is in it.

When a particle consisting of both Yeho and Va is found in the Va field, it is affected by both components of the field.

It is important to note that unlike conventional fields (gravitational for instance) are single component fields, the Yeho and Va fields are double component fields.

The Structure of Matter in the Heavenly Environment

As was mentioned earlier the structure of every particle carrying the two entities Yeho and Va is a structure in which the bond between them is strongest. This type of structure is a structure of concentric spheres (FIG. 1). The following is a more detailed analysis of this structure. The analysis is based on two facts previously stated:

1. The attractive force between the Va in the center and the Yeho that surround it is in inverse ratio to r^{a},

2. Between every two Yeho there's a repellent force in inverse ratio to rⁿ,

From these two facts one can deduce that:

1. The “density” of the layers of Yeho which are wrapped around the Va diminishes as the distance from the center grows:

2. The volume of the ball of Yeho is relatively bigger than the ball of Va (FIG. 1).

This structure enables us to explain also what happens when two such particles approach each other. As long as the distance between the particles is very large in relation to their dimensions, it is possible to treat the particles as point particles. In these instances the calculation of forces can be done as though all the Yeho and all the Va of each of them are concentrated at its center.

When the distance between the centers of the particles is in the size range of their radii, one must consider the structure just mentioned. Meaning, it is no longer possible to talk of one distance between the particles, and the different distances between the various entities, like the distance between the two Va and the distance between the outer layers of the two Yeho, must be taken into account. When these layers get close enough to touch each other, the distance between the two Va is still comparatively large, the resulting structure is in equilibrium when the attractive and repulsive forces balance, in other words when the resultant force equals zero.

In order to separate the two particles which are in equilibrium external forces need to be applied (much in the same way as force needs to be applied to separate attached magnets which are in equilibrium). The strength of the required force depends of course on the amount of Yeho and the amount of Va in each of them (in the same way that the force required to separate two attached magnets depends on the strength of the magnets). The strength of the separating force serves as measure of the bond strength or alternatively the freedom of motion between the two attached particles.

In the heavenly environment matter appears in three phases, and it can under certain conditions pass from one phase to another. The three phases are: solid, liquid and gas.

Following is an explanation of the structure of matter in these three phases.

Solid—A phase in which the strength of the force required to separate the particles of matter is large. In other words, there's practically no freedom of motion between the particles of the solid.

Liquid—A phase in which the strength of the force required to separate the particles of matter is small. In other words, the particles of the liquid enjoy freedom of motion. The freedom is at such a level that an external power operating on the liquid can quite easily cause a change in its form.

Gas—A phase that is totally different from the previous two phases. In this phase the “quantity” of the Yeho is great and also its radius is large in compared with the size of the Va. Consequently the resultant force acting on each of the particles in a condition of almost touching is a repulsive force, under the influence of which the particles are pushed away from each other.

This separation process helps explains in a very simple way several phenomena which are characteristic to gases:

1. Gas that is inserted into an empty vessel through an aperture that is directed in a certain direction, almost immediately occupies the full volume of the vessel, regardless of the direction from which it enters.

2. Two different gases that are inserted into an empty vessel, from different apertures and from different directions homogeneously mix with each other practically immediately.

3. Gas found in a vessel applies pressure on the walls of the vessel. The source of this pressure is in the mutual repulsive forces between the gas particles which are getting away from one another and between the walls of the vessel which are also made of Yeho and Va components.

4. The immediate passage of gas through a tube affixed to the wall between two vessels A and B (In vessel A there is gas and in vessel B there's vacuum), while the rate of exit practically doesn't change when the tube is made of “broken” segments perpendicular to each other as described in FIG. 5.

As can be seen, there are even several phenomena in nature for which the current explanation seems doubtful are quite reasonably and easily explained by the forces that operate in the heavenly environment.

Molecules and Chemical Reaction

In the heavenly environment the atoms can unite with each other to form is molecules. Likewise, chemical interactions can occur between the atoms and the molecules of different substances.

Molecules are created when two, or more, Va, wrapped in a casing of Yeho unite so that a single joint casing is formed (FIG. 6)

The greater the quantity of joint Yeho, the molecule becomes more stable.

Chemical reactions may occur while emitting or absorbing excess Yeho. The degree of the “strength of the chemical bond depends on the mutual forces between the components of the Yeho and the Va. Also in this case a joint casing of Yeho is formed, and the higher the quantity of joint Yeho, the stronger the chemical bond.

It's not impossible that the structure of the nucleus of the atom is similar, at least partly.

Various Characteristics of Substances in the Heavenly Environment

Temperature

Temperature is a measure for the ability of a substance to absorb or release Yeho. This ability depends, of course, on the strength of the bond between the Yeho and the Va. The stronger this bond, the smaller the ability to release Yeho becomes.

Expansion of Bodies when Heated

During heating, The Va in the substance absorbs an additional quantity of Yeho which joins the Yeho already surrounding it. As a result the repulsive forces between every two adjacent Yeho grows until a new equilibrium is created in which the distances between every two adjacent Va increases In other words, the substance expands. Likewise, as a result of the growth in the distance between every two adjacent Va, the force required for the separation of the particles decreases, and the freedom of motion of the particles of the substance grows.

Changes of Phase

When the addition of Yeho to a solid is sufficiently big, the forces required to separate the particles decrease to such a degree that the freedom of motion of the particles grows and the phase of the substance changes accordingly. This explanation is also valid for the evaporation process of liquids.

Elasticity

The application of an external stretching force to solid increases the distance between its particles and the body becomes longer. As long as this force isn't greater than the force required for separating the particles from each other, the body returns to its original condition immediately after the external force is removed. But when the external force exceeds the separation force, the distance between the particles increases to such a degree that the body is torn. The different elasticity of different substances is explained by the varying degrees of binding power of the different substances.

Heat Capacity

The quantity of the Yeho required for changing the temperature of a body by 1° C. This quantity depends on the ratio between the quantities of the Yeho and the quantities of the Va in the body. Heat capacity also serves as an index to the ability of the body to absorb and release Yeho.

As can be seen, these concepts in the heavenly realm are similar to the concepts used in our world.

The Yeho as a Wavy Entity

The Yeho can appear in the heavenly environment in two forms

An absolutely independent entity

A casing of Va

In order to explain various phenomena that occur in our world we probably have to assume that: The Yeho entity possesses also a wavy behavior, linked to the abovementioned Yeho field.

A Yeho wave which propagates (also in the void), possesses all the characteristics of a wave: frequency, wave length and speed of propagation. All the phenomena typical to waves occur in these waves: interference, diffraction, polarization, standing waves etc.

When the Yeho surrounds a nucleus of Va, wavy properties can be attributed to it. If so far we said that the “density” of the Yeho casing diminishes as we get closer to the outer surface, we now can assume that this casing isn't continuous, but is made in the form of shells at radii that enable the creation of standing Yeho waves.

As we mentioned above every Va is surrounded by Yeho, it is therefore almost obvious that the movement of the Va which is “wrapped” in Yeho, is also accompanied by wavy phenomena like interference and diffraction, which are influenced by among others things by concentrations of Va surrounded by Yeho at close proximity to its route (like the edges of the slit through which it passes or its path through a crystal).

When the Yeho wave moves far from Va bodies surrounded by Yeho, it moves in straight lines and at a constant speed which is dependent on the “density” of the Yeho. But when the Yeho wave moves in close proximity of bodies in which there's a high concentration of Va it is influenced by them, causing changes in the direction of its motion and probably also in the frequency of the wave. This change in frequency is manifested among others also by the Red Shift phenomena, which as is well known can't be attributed solely to the motion of the heavenly bodies.

The Atom and the Nucleus in the Heavenly Environment

The Structure of the Atom

The atom is constructed of a nucleus around which there are electrons. Both the nucleus and the electrons are made of Va which is surrounded by Yeho. The electrons do not collapse towards the nucleus because between the Yeho of the nucleus and the Yeho of the electrons repulsive forces exist counterbalancing the attractive forces between their Va and the attractive forces between the Va and the Yeho.

### The Photoelectric Effect

Free Yeho which collide with matter join the Yeho of the atoms of the matter. As a result the repulsive force between the components of the atom causes some of the electrons to be ejected from the matter.

The ejection of the electron occurs when the frequency of the Yeho is greater than the threshold frequency of the matter. Bellow this threshold frequency the Yeho joins the Yeho of the components of the atom causing, among other things, a rise in temperature. Above this threshold frequency the joining of the Yeho causes a rise in the repulsive forces, as a result of which a process of ejecting an electron may occur.

### The Compton Effect

A free Yeho approaching an electron which consists of Va surrounded by Yeho, can under certain conditions deliver to it some of its Yeho and due to the mutual repulsive forces between the Yehos both the electron and the free Yeho change their speed and the direction of their motion.

### Radioactive Disintegrations

The phenomenon of radioactivity is a result of instability of the nucleus (in Isotopes in which the phenomenon occurs). The source of this instability lies in the unstable structure of the Yeho and the Va of the components of the nucleus. The statistical property of the disintegration and the need to use the term half a life span, for describing the disintegration probably attest to an additional fact: It's possible that different nuclei of the same isotope have structures of Yeho and Va which slightly differ from one another. This structure is probably dynamic and is probably affected by the disintegration of adjacent nuclei. The result is that different nuclei become unstable at different times, and therefore the disintegration doesn't occur in all the nuclei concurrently.

The Universe in the Heavenly Environment

In the vast distances between the bodies in the universe the ruling force is the repulsive force between the Yeho that surrounds the Va of these bodies. This force explains first and foremost the fact that the universe doesn't collapse into itself. But it also explains other phenomena like:

### The Solar Wind

Between the Yeho and the Va of the Sun and the Yeho and Va of particles found in its vicinity forces are active. Starting from certain quantities of Yeho, the resultant force acting on these particles is the repulsive force, so they move in the direction from the Sun outwards.

The Diversion of the Tail of a Comet Passing Near the Sun

The particles of the tail of a comet are far from one another due to the repulsive forces between their Yeho. These forces are joined by the repulsive forces of the huge quantity of Yeho that surrounds the Sun, causing a diversion of the tail of the comet in the direction from the Sun outwards.

Black Holes

A black hole is a heavenly body in which there is a very high concentration of Va which attracts with huge force bodies that pass near it. The Va of the black hole is, of course, also surrounded by Yeho. The very high concentrations of the Va and of the Yeho in the black hole may cause the Yeho of the joining body to tear from its Va. As a result the Va of the body joins the Va of the black hole while its Yeho joins the casing of Yeho of the black hole and/or is rejected from it. This rejection of Yeho could possibly explain the radiation emitted by black holes.

Situations are possible in which the resultant force acting on a body far away from the black hole is balanced (zero) or even turns into a repulsive force. This may explain why the whole universe doesn't collapse into the black holes and why bodies are discovered around black holes.

### Electricity and Magnetism

Three forces are active in the heavenly environment. Two of them are attractive forces and one is a repulsive force. Changes in the quantities of the Yeho and the Va, by a passage of electrons for instance, may turn “neutral” bodies, i.e. bodies between which equilibrium exists, into bodies that attract or repel one another. If in addition we'll assume that the electron is constructed of a relatively small Va Surrounded by a relatively big Yeho, situations may be possible in which the resultant force acting on free electrons is a repulsive force the result of which may be manifested by motion, i.e. an electrical current.

The movement of the Va particles surrounded by Yeho could change the ratios between the attractive and repulsive forces, and in doing so explain the creation of the forces currently called magnetic forces.

Predictions of the Heaven Theory

Like any new theory, this theory too, is required not only to explain the known phenomena of nature, but also to predict unknown phenomena. Following are a few phenomena that are supposed to occur in the heavenly environment:

The Dependence of the Gravitational Force Acting Between Two Bodies on Temperature.

When we'll perform the Cavendish experiment (an experiment in which the intensity of the gravitational force acting between two close bodies is measured) it will be discovered that the gravitational force also depends on the temperature of the attracted bodies.

### The Solar Wind

The Va particles surrounded by Yeho which are found in space, and the resultant force applied to them by the Sun may cause them to get nearer to it. During their motion they absorb Yeho from the Sun, so that the repulsive force acting on them increases progressively. Consequently it could happen that the resultant force on them due to the Sun may change direction, i.e. at a certain stage of their motion they may stop, and even start moving away from the Sun.

The Micro Radiation in the Universe

The micro radiation discovered across the space of the universe is free Yeho originating in very far away galaxies, which underwent a Red Shift. This acute shift is probably a result of an accumulated change in frequency caused by the passage of the Yeho near concentrations of Va encased in Yeho.

Links Between the Constants Characterizing Different Substances

Every substance is characterized by a number of physical constants like atomic mass, density, thermic expansion coefficient, specific heat capacity, elasticity coefficient and more. As far as we know no connections/relations were found between these constants. We can assume that solving the equations dealing in the equilibrium which is created under the influence of the forces between the entities—Yeho and Va, will point to definitive mathematical relations between these constants.

Yeho Emission

Two fast electrons composed of Va wrapped in Yeho, and maybe other basic particles may emit part of their Yeho as they pass one another.

The Circumvention of an Electron

The passage of a single electron through a crack or several cracks (a crystal for instance), will be accompanied by a diffraction. This diffraction is a result of the interaction between the Yeho which encases the Va of the electron with the Yeho that encases the Va of the substance around the crack (in the case of passage through a crystal the interaction is with the Yeho that encases the Va of the atoms of the crystal).

Interference of an Electron with Itself

The collision of a very fast electron with a barrier in which there are two cracks S1 and S2 (FIG. 7) will cause an interference pattern on the other side of the barrier. The electron that is swallowed by the barrier emits Yeho through the cracks causing the Yeho passing through the different cracks to interfere with one another. The interference pattern will disappear if the two cracks will be on two separate barriers (FIG. 7).

The Fractal Structure of the Basic Particles and of the Universe

As mentioned before every material entity is composed of Va encased in Yeho.

It isn't impossible that if we manage to penetrate into the Va we'll find an internal structure which repeats itself in a pattern known as fractals. It is also not impossible that a fractal structure will also be discovered in the universe, i.e. “universes” will be discovered which repeat themselves in a fractal pattern.

The Links Between the Terms of the Heavenly Environment and the Terms of Current Science

If the model presented here is indeed the model that will replace the current theories relating to the structure of matter and the universe. It is reasonable to assume that the following connections/relations will be discovered:

Va is but a broadening of the term mass, but while mass stands alone, there is practically no Va which isn't wrapped in Yeho. If that is indeed so it would be reasonable to assume that the exponent of the distance in the formula calculating the attractive forces between every two Va is approximately 2, similar to the exponent in the formula for the gravitational force.

This assumption also affects the value of the exponents of the distance in the formulae for calculating the other two forces that prevail in the heavenly environment. it can be said that the exponent of the distance in the formula for calculating the repulsive force acting between every two Yeho may be in the first approximation 1, and the exponent of the distance in the formula for calculating the attractive force operating between Yeho and Va may be at first approximation 3.

$${F}_{YY} = {k}_{1} \frac{{Y}_{1} {Y}_{2}}{r} ; {F}_{VV} = - {k}_{2} \frac{{V}_{1} {V}_{2}}{{r}^{2}} ; {F}_{YV} = - {k}_{3} \frac{{Ý}_{1} {V}_{2}}{{r}^{3}}$$

Yeho is the electromagnetic wave.

The interaction between Yeho and Va can explain all the links between radiation and matter, the duality of the radiation and the matter, and possibly even the huge emission of energy in nuclear processes.

Assuming that the Yeho that surrounds the Va is a stationary wave, having a frequency that increases as one approaches the center of mass or the Va, and increasing “density”, this may explain the electromagnetic spectrum of emissions from various emitting materials, and the spin options of the Yeho (standing wave) may explain the electrical and magnetic forces.

### Summary of Theory

The revolutionary theory described above assumes that our world is constructed of two entities which we have called: Yeho and Va

Three forces operate between these entities:
Between every two Yeho a mutual repulsive force is in operation—Fyy
Between every two Va a mutual attractive force is in operation—Fvv
Between Yeho and Va a mutual attractive force is in operation—Fyv

The dependence of these forces on the distance (at least at first approximation) is:

$${F}_{YY} = {k}_{1} \frac{{Y}_{1} {Y}_{2}}{r} ; {F}_{VV} = - {k}_{2} \frac{{V}_{1} {V}_{2}}{{r}^{2}} ; {F}_{YV} = - {k}_{3} \frac{{Y}_{1} {V}_{2}}{{r}^{3}}$$

We have also seen that the use of these entities and the interactions between them can explain in a relatively simple manner most of the phenomena known today, starting with the subatomic level and ending at the cosmic level.

As was already mentioned in the opening paragraphs, the theory presented here is only the first layer and it requires further work based on laboratory measurements and detailed mathematical analyses. It may, therefore, be assumed that if and when it is accepted it will include corrections, improvements and additions. The full and accurate formulation will, of course, require the intellectual and mathematical abilities of the scientists.

It is not impossible that in time new phenomena will be discovered that will necessitate the addition of an entity, or several entities, which also interact with the entities presented here, and that the dependence of these interactions on distance is at different exponents from the ones characterizing the interactions that were described here (including an exponent of 0, which means independence of the force from the distance).

In the Nuclear Fusion process huge quantities of energy are released, but also the energies required to perform the process are very big.

Two principal methods for the performance of the process are currently known:
(a) Heating to very high temperatures, in order that the collisions between the fusing nuclei will be sufficiently energetic. Calculations show that the required temperatures and pressures are on a par with the temperatures and pressures prevailing on the sun and this is indeed the process occurring on the sun.
(b) These temperatures and pressures can also be reached in an explosion of an atomic bomb which activates a hydrogen bomb. But this process is short lived and the huge emission of energy cannot be controlled and/or exploited in a controlled manner.

Using accelerators which provide the nuclei with the required energies. But this process isn't economically viable due to the energy balance it produces.

All the above indicates that performing a nuclear fusion in a slow and controlled process isn't possible or economically viable, in the currently known methods.

### Examples of Fusion Processes:

Two Deuterium nuclei ₁²H and proton. ₁¹H are fused into a Tritium nucleus ₁³H

₁²H+₁²H→₁³H+₁¹H

Two Tritium nuclei ₁² Hare fused into a Helium nucleus ₂³He and a free neutron ₀¹n

₁²H+₁²H→₂³He+₀¹n

### SUMMARY OF THE INVENTION

The present invention is directed to a system and method for cold fusion. It is based on a novel scientific theory by the inventor, Raphael Adler, titled Shattering the Big Bang, which is available from the Jewish National Library, Hebrew University of Jerusalem, Israel. published by the Inventor It is stressed however, that the process and system of the invention should be weighed up in terms of their utility, novelty and inventiveness, without regard to the accuracy of novel theories explained hereinabove.

In a first aspect, the present invention is directed to providing a method for producing nuclear fusion in a fusion chamber, comprising the steps of:

(a) Obtaining cooled high velocity nuclear particles;
(b) Causing said particles to impact a target, and
(c) Harvesting the energy thereby released.

In some embodiments, obtaining high velocity nuclear particles is by: (i) Cooling high velocity nuclear particles, and (ii) Accelerating said high velocity nuclear particles by an accelerating means, into an impact chamber.

In other embodiments, obtaining cooled high velocity nuclear particles is by: (i) Cooling a source of nuclear particles, and (ii) Accelerating the nuclear particles by an accelerating means, into an impact chamber.

In some embodiments, obtaining cooled high velocity nuclear particles is by forming high velocity nuclear particles and then cooling the high velocity nuclear particles formed.

Optionally, the target is cooled.

Optionally, cooling is cooling to a temperature of near OK.

Alternatively, the cooling is cooling to a temperature of below 4K.

Alternatively, the cooling is cooling to a temperature of below 40K.

Alternatively, the cooling is cooling to a temperature of below 100K.

Alternatively, the cooling is cooling to a temperature of below 273K.

In the various embodiments, the source may be selected from the list of solids, liquids, gases, plasmas, ions, isotopes and radioactive materials.

In the various embodiments, the charged particles are selected from the list of anions, cations, alpha particles, beta particles and radioactive species.

In the various embodiments, the acceleration means may comprise electromagnetic fields.

In some embodiments, the acceleration means may accelerate the particles to an acceleration of zero.

The target may be selected from the list of accelerated nuclear particles, ions, isotopes, gases, plasmas, solids and liquids.

Optionally and preferably, the harvesting is by a heat exchanger.

Optionally, the impact chamber is a low vacuum chamber. Alternatively, the impact chamber is a high vacuum chamber. Alternatively again, the impact chamber is a vacuum chamber of variable vacuum.

In the various embodiments, the energy released is managed by controlling at least one of the following list:
(i) rate of generation of nuclear particles;
(ii) acceleration of nuclear particles by electromagnetic acceleration means;
(iii) processing temperature;
(iv) absorption;
(v) temperature, and
(vi) no of available targets.

Optionally, the impacting particles have different spins.

Preferably non-impacting particles can be redirected into the fusion chamber and thereby recycled.

In some embodiments, the probability of impact is increased by fields selected from the list of electrical fields, magnetic fields and electromagnetic fields.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic representation showing a Va in the center of a particle with the Yeho surrounds it.

FIG. 2 is a schematic representation showing a stage when the attractive force is stronger than the repulsive force, and the approaching Yeho is combined with the Yeho that is within the envelope.

FIG. 3 is a schematic representation showing the stage when the repulsive force acting on every additional approaching Yeho overcomes the attractive force and its absorption is prevented.

FIG. 4 shows a graph of the forces and of the resultant force ΣF as a function of separation r (In drawing the graph it was assumed that: n₁=1, n₂=2 and n₃=3)

FIG. 5 is a schematic representation of an impact chamber that may be used for reducing the present invention to practice;

FIG. 6 sows how molecules may be created when two, or more, Va, wrapped in a casing of Yeho unite so that a single joint casing is formed;

FIG. 7 shows how the interference pattern disappears if two slits are on two separate barriers

FIG. 8 is a conceptual block diagram of the fusion apparatus.

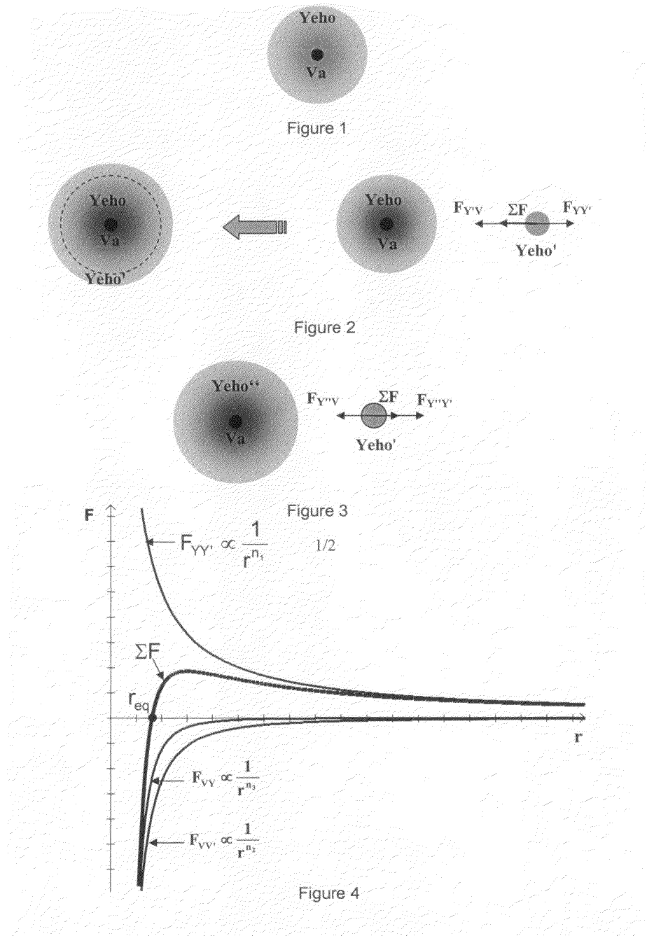

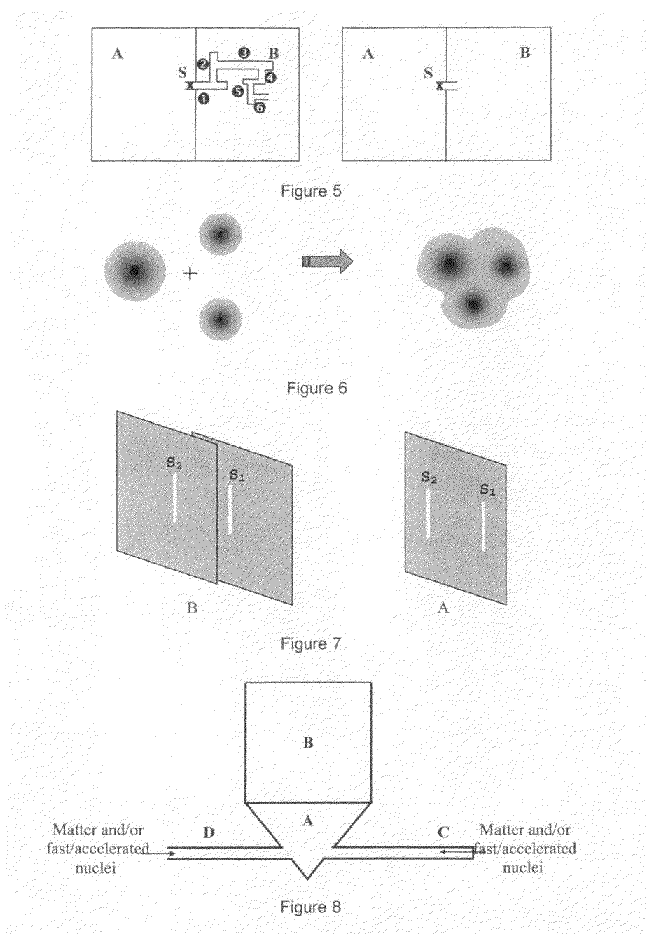

### DETAILED DESCRIPTION OF THE EMBODIMENTS

In the Nuclear Fusion process huge quantities of energy are released, but also the energies required to perform the process are very big. Two principal methods for the performance of the process are currently known:

(a) Heating to very high temperatures, in order that the collisions between the fusing nuclei will be sufficiently energetic. Calculations show that the required temperatures and pressures are on a par with the temperatures and pressures prevailing on the sun, and this is indeed the process occurring on the sun.

These temperatures and pressures can also be reached in an explosion of an atomic bomb which activates a hydrogen bomb. But this process is short lived and the huge emission of energy cannot be controlled and/or exploited in a controlled manner.

(B) Using accelerators which provide the nuclei with the required energies. But this process isn't economically viable due to the energy balance it produces.

Referring now to FIG. 8, a novel cold fusion system is shown. The system includes:
A first vessel A in which the fusion process is performed. The pressure in the vessel is low, preferably vacuum or near vacuum.
A second Vessel B which serves as a heat converter between vessel A and the system of pipes which extracts the produced heat from the facility outside.
Two pipes C and D which enter vessel A with their apertures facing each other.

Fast/accelerated nuclei/particles of matter, here forth particles, move along these pipes. Upon entering vessel A the particles collide with each other. The direction of the movement of the particles is controlled by fields which apply to them forces like magnetic fields, electric fields etc.

In order to increase efficiency, it is preferable that those particles that didn't undergo fusion can be redirected into pipes C and D for a repeat performance of the process.

A novel cold fusion process is also proposed:

Step (i): A beam/beams of particles (not necessarily of the same element), here forth beam, is entered through pipes C and D into vessel A (FIG. 8). The pressure inside the pipes and vessel A is low, under preferable conditions vacuum or near vacuum is required.

Step (ii): The source of the beam or particles ejected therefrom are cooled to a low temperature.

Preferably at or near absolute zero (−273 C). The matter serving as the source of the beam is preferably matter that underwent ionization processes or matter that spontaneously emits the particles, like radioactive matter, or any matter in the atoms of which the number of protons differs from the number of electrons.

It is possible that in order to facilitate the process an acceleration of the beam may be required.

When the source of the beam is matter at low temperature, the energy the beam has to be provided with, is significantly lower than the energy it has to be provided with when the source of the beam is at higher temperatures.

In order to increase efficiency under preferable conditions those particles that didn't undergo fusion can be redirected into pipes C and D for a repeat performance of the process.

(Step (iii) The energy emitted during the fusion process occurring in vessel A is extracted into vessel B and from there onto a system for utilizing that energy. For example, to a system of turbines which are connected an electricity generating facility. The heat converter, under preferable conditions consists of a system of pipes containing a heat conducting fluid.

Controlling the quantity of mater in the beam, the speed of the particles in the beam and the temperature in which the process occurs, will enable a controlled performance of the process so that the pace of energy emission can be controlled.

It is believed that the method and system of the present invention has the following advantages:
The ability to control the pace of the nuclear fusion process.
The energy required to perform the fusion in this process is significantly lower than the energy required in the currently known methods, making this process economically worthwhile.

Persons skilled in the art will appreciate that the present invention is not limited to what has been particularly shown and described hereinabove. Rather the scope of the present invention is defined by the appended claims and includes both combinations and subcombinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method for producing nuclear fusion in a fusion chamber, comprising the steps of:
(a) Obtaining cooled high velocity nuclear particles;
(b) Causing said particles to impact a target, and
(c) Harvesting the energy thereby released.

2. The method of claim 1, wherein said obtaining high velocity nuclear particles is by: (i) Cooling high velocity nuclear particles, and (ii) Accelerating said high velocity nuclear particles by an accelerating means, into an impact chamber

3. The method of claim 1, wherein said obtaining high velocity nuclear particles is by: (i) Cooling a source of nuclear particles, and (ii) Accelearating the nuclear particles by an accelerating means, into an impact chamber.

4. The method of claim 1, wherein said obtaining high velocity nuclear particles is by forming high velocity nuclear particles and then cooling the high velocity nuclear particles formed.

5. The method of claim 1 wherein the target is cooled.

6. The method of claim 1 wherein said cooling is cooling to a temperature of near 0 K.

7. The method of claim 1 wherein said cooling is cooling to a temperature of near 4 K.

8. The method of claim 1 wherein said cooling is cooling to a temperature of below 40 K.

9. The method of claim 1 wherein said cooling is cooling to a temperature of below 100 K.

10. The method of claim 1 wherein said cooling is cooling to a temperature of below 273 K.

11. The method of claim 1, the source is selected from the list of solids, liquids, gases, plasmas, ions, isotopes and radioactive materials.

12. The method of claim 1, wherein said charged particles are selected from the list of anions, cations, alpha particles, beta particles and radioactive species.

13. The method of claim 1, wherein said acceleration means comprises electromagnetic fields.

14. The method of claim 1, wherein said acceleration means accelerates said particles to an acceleration of zero.

15. The method of claim 1, wherein said target is selected from the list of accelerated nuclear particles, ions, isotopes, gases, plasmas, solids and liquids.

16. The method of claim 1, wherein said harvesting is by a heat exchanger.

17. The method of claim 1, wherein said impact chamber is a low vacuum chamber.

18. The method of claim 1, wherein said impact chamber is a high vacuum chamber.

19. The method of claim 1, wherein said impact chamber is a vacuum chamber of variable vacuum.

20. The method of claim 1, wherein the energy released is managed by controlling at least one of the following list: (i) rate of generation of nuclear particles; (ii) acceleration of nuclear particles by electromagnetic acceleration means; (iii) processing temperature; (iv) absorption;
(v) temperature, and (vi) no of available targets

21. The method of claim 1, wherein impacting particles have different spins.

22. The method of claim 1 wherein non-impacting particles can be redirected into the fusion chamber.

23. The method of claim 1 wherein probability of impact is increased by fields selected from the list of electrical fields, magnetic fields and electromagnetic fields.

24. The method of claim 1 wherein said target is a particle which becomes unstable as a result of the impact and consequently decays, releasing energy thereby.
